(19) United States
(12) Patent Application Publication
(10) Pub. No.: US 2026/0331797 A1
(43) Pub. Date: Oct. 22, 2026

(54) DUPLEX CONNECTOR

(71) Applicant: ASIA VITAL COMPONENTS CO., LTD., New Taipei City (TW)

(72) Inventors: Sung-Wei Sun, New Taipei City (TW); Feng Liu, New Taipei City (TW); Yong Xiang, New Taipei City (TW); Cun-Bao Lyu, New Taipei City (TW); Bing Liu, New Taipei City (TW)

(21) Appl. No.: 19/238,676

(22) Filed: Jun. 16, 2025

(30) Foreign Application Priority Data
Apr. 21, 2025 (TW) 114115036

(51) Int. Cl. H01R 12/70; H01R 12/71; H01R 13/50

(52) U.S. Cl. CPC H01R 12/7076; H01R 12/71; H01R 13/50; H01R 2201/06

(57) ABSTRACT

A duplex connector includes a body and a plurality of pins inserted into the body and not connected to each other, the body having a top end and a bottom end, each pin having a first contact portion and a second contact portion, wherein the first contact portion extends through the top end and the second contact portion extends through the bottom end, enabling the above connector to connect a first circuit board and a second circuit board. The first contact portion of each pin is inserted into a first receiving portion of the first circuit board, the second contact portion of each pin is inserted into a second receiving portion of the second circuit board, thereby electrically connecting multiple circuit boards to expand the space for disposing electronic components, provide more functions, and allow replacement of damaged parts during maintenance, achieving the advantages of expanded space and maintenance convenience.

This application claims the priority benefit of Taiwan patent application number 114115036 filed on Apr. 21, 2025, the disclosure of which is hereby incorporated by reference in its entirety.

### FIELD OF THE INVENTION

The present invention relates to the field of connectors and circuit boards, and in particular to a duplex connector and circuit board.

### BACKGROUND OF THE INVENTION

In the current field of fans, a circuit board is typically singularly installed on either the front side or the rear side of a fan frame base, and circuit components for controlling and driving the fan are disposed on the circuit board, enabling the fan to provide diverse functions through the planning and design of the circuit board.

However, with technological advancements, the functional requirements for fans have increased, and within a limited space of a fan, no matter how miniaturized electronic components become or how optimized the circuit layout is, the issue of insufficient circuit board space will eventually arise, meaning that compromises must be made by sacrificing certain functions.

Therefore, addressing and improving the issue of insufficient circuit board space in current fans is a critical direction for the inventor of this application and related industry manufacturers to research and improve.

### SUMMARY OF THE INVENTION

To address the above issue, the present invention provides a duplex connector that maximizes the use of available space within a fan, enabling disposition of multiple circuit boards at different positions on a fan frame base and electrically connecting the multiple circuit boards through the connector.

To achieve the above object, the present invention provides a duplex connector, comprising: a body having a top end and a bottom end, the top end and the bottom end being respectively disposed at opposite ends of the body; and a plurality of pins being inserted into the body and not connected to each other, each pin having a first contact portion, a second contact portion, and a conductor portion positioned between the first contact portion and the second contact portion, wherein the first contact portion of each pin extends through the top end, the second contact portion of each pin extends through the bottom end, and the conductor portion of each pin is embedded within the body.

The present invention further provides a fan structure with a duplex connector, comprising: a fan frame, the fan frame having a base, the base including a first receiving slot and a second receiving slot respectively disposed on upper and lower sides thereof; a first circuit board having a first receiving portion, disposed in the first receiving slot; a second circuit board having a second receiving portion, disposed in the second receiving slot; and a duplex connector comprising: a body, the body having a top end and a bottom end; a plurality of pins, each having a first contact portion, a second contact portion, and a conductor portion positioned between the first contact portion and the second contact portion, the pins being inserted into the body and not connected to each other; wherein the first contact portion of each pin extends through the top end and is inserted into the first receiving portion, the second contact portion of each pin extends through the bottom end and is inserted into the second receiving portion, and the conductor portion of each pin is embedded within the body.

By means of the above structure, the connector electrically connects multiple circuit boards, significantly increasing the overall area, thereby providing more space for disposing additional electronic components, and the multiple circuit boards can be respectively disposed on the upper and lower sides of the fan frame base, greatly increasing the space for installing electronic components. During future maintenance, only the damaged parts need to be replaced, achieving the advantages of expanded space and maintenance convenience.

### BRIEF DESCRIPTION OF THE DRAWINGS

The structure and the technical means adopted by the present invention to achieve the above object can be best understood by referring to the following detailed description of the preferred embodiments and the accompanying drawings, wherein

FIG. 1A is a three-dimensional schematic view of the duplex connector of the present invention;

FIG. 1B is a three-dimensional schematic view of the duplex connector of the present invention from a different angle;

FIG. 1C is a cross-sectional schematic view of the duplex connector of the present invention.

### DETAILED DESCRIPTION OF THE PREFERRED EMBODIMENTS

The present invention will be described with some preferred embodiments thereof and by referring to the accompanying drawings.

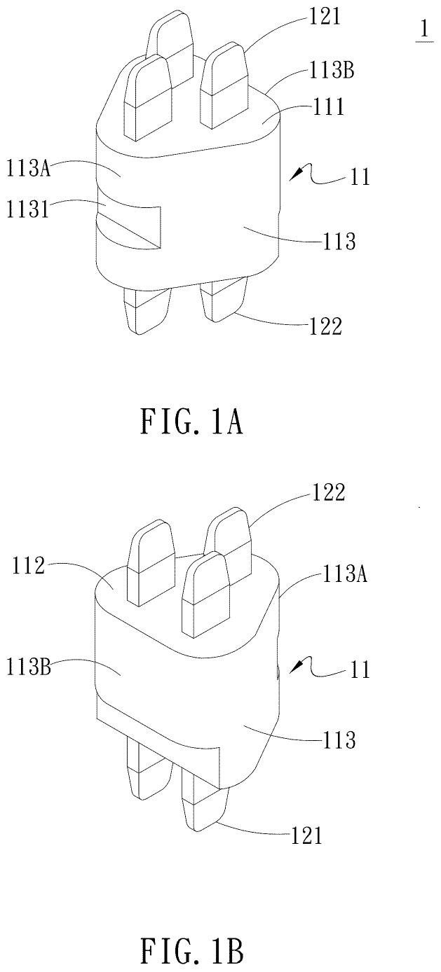

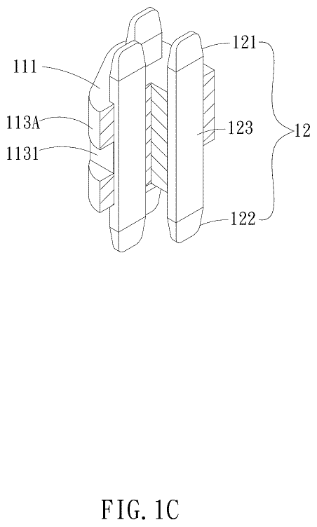

Referring to FIGS. 1A, 1B, and 1C, which are three-dimensional schematic views, and a cross-sectional schematic view of the duplex connector of the present invention, the duplex connector 1 mainly comprises a body 11 and a plurality of pins 12, and the specific structure of the duplex connector 1 will be described in detail below.

The body 11 has a top end 111, a bottom end 112, and a sidewall 113 located between the top end 111 and the bottom end 112. In this embodiment, the top end 111 and the bottom end 112 are planar, the sidewall 113 defines a first arcuate side 113A and a second arcuate side 113B, the first arcuate side 113A and the second arcuate side 113B having different curvatures, such a structure provides a foolproof effect to prevent incorrect installation during subsequent installation, effectively preventing incorrect installation direction. In this embodiment, the first arcuate side 113A further includes a groove 1131, the groove 1131 being optionally formed, the groove 1131 reducing the material usage of the body 11, achieving the effects of weight reduction and cost reduction. The material of the body 11 is selected from thermoplastic non-conductive materials, such as plastic or nylon.

Each of the pins 12 has a first contact portion 121, a second contact portion 122, and a conductor portion 123 positioned between the first contact portion 121 and the second contact portion 122, the pins 12 being sequentially inserted into the body 11 and not connected to each other. The first contact portion 121 of each pin 12 extends through the top end 111 of the body 11, the second contact portion 122 of each pin extends through the bottom end 112 of the body 11, and the conductor portion 123 of each pin 12 is embedded within the body 11. The body 11 can be fixed to the pins 12 by overmolding or insert molding, or holes sufficient for inserting the pins 12 can be pre-formed on the body 11 and then assembled by tight fitting. In this embodiment, the number of pins 12 is three, arranged in a staggered manner, and the total number and arrangement of the pins 12 are determined based on usage requirements and circuit planning, without limitation thereto.

The circuit board of the present invention mainly comprises a first circuit board and a second circuit board, the first circuit board and the second circuit board being respectively disposed on the upper and lower sides of a base of a fan frame.

The following will describe in detail how the circuit board is disposed in the fan frame, and the specific combination of the circuit board, the duplex connector 1, and the fan frame.

First, the detailed structure of the fan frame is described below. The fan frame has a base at its center, the base including a first receiving slot and a second receiving slot on its two sides, and the base further includes a connector mounting hole located between the first receiving slot and the second receiving slot. In this embodiment, the connector mounting hole is shaped to match the body 11 of the duplex connector 1, enabling the duplex connector 1 to be securely installed, embedded, or mounted in the connector mounting hole.

Although the above embodiment is described with reference to an axial flow fan, it is not limited thereto and can be applied to centrifugal fans or other types of fans. The type of fan is not the focus of this application and will not be further elaborated.

The first circuit board has a first receiving portion, and the second circuit board has a second receiving portion. The first circuit board is disposed in the first receiving slot with the first receiving portion connected to the first contact portion, and the second circuit board is disposed in the second receiving slot with the second receiving portion connected to the second contact portion. The first and second circuit boards can be single-layer or multi-layer boards, and electronic components for achieving various fan functions are disposed on the surfaces of the first and second circuit boards.

It can be clearly understood that the present invention fully utilizes the space on the upper and lower sides of the base, forming the first and second receiving slots to accommodate the first and second circuit boards, and electrically connecting the first and second circuit boards through the duplex connector 1, doubling the circuit space through the use of two circuit boards, thereby enabling a fan with more diverse functions. Furthermore, during future fan maintenance, only the damaged parts need to be replaced, achieving the advantages of expanded space and maintenance convenience.

In summary, the advantages of the present invention are as follows:
1. Increase circuit installation space;
2. Convenient maintenance.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A duplex connector, comprising:
a body having a top end and a bottom end, the top end and the bottom end being respectively disposed at opposite ends of the body; and
a plurality of pins, each pin having a first contact portion, a second contact portion, and a conductor portion positioned between the first contact portion and the second contact portion, the pins being inserted into the body and not connected to each other;
wherein the first contact portion of each pin extends through the top end, the second contact portion of each pin extends through the bottom end, and the conductor portion of each pin is embedded within the body.

2. The duplex connector as claimed in claim 1, wherein the body includes a sidewall located between the top end and the bottom end, the sidewall defining a first arcuate side and a second arcuate side, the first arcuate side and the second arcuate side having different curvatures.

3. The duplex connector as claimed in claim 2, wherein the first arcuate side includes a groove.

4. The duplex connector as claimed in claim 1, wherein the body is made of a nylon material.
